(19) United States
(12) Patent Application Publication
(10) Pub. No.: US 2025/0265488 A1
(43) Pub. Date: Aug. 21, 2025

(54) QUANTUM ERROR CORRECTION HARDWARE DECODER AND CHIP

(71) Applicant: TENCENT TECHNOLOGY (SHENZHEN) COMPANY LIMITED, SHENZHEN (CN)

(72) Inventors: Mengyu ZHANG, SHENZHEN (CN); Guanglei XI, SHENZHEN (CN); Yicong ZHENG, SHENZHEN (CN); Shengyu ZHANG, SHENZHEN (CN); Xiangyu REN, SHENZHEN (CN)

(73) Assignee: TENCENT TECHNOLOGY (SHENZHEN) COMPANY LIMITED, SHENZHEN (CN)

(21) Appl. No.: 19/178,033

(22) Filed: Apr. 14, 2025

Related U.S. Application Data
(63) Continuation of application No. PCT/CN2023/132891, filed on Nov. 21, 2023.

(30) Foreign Application Priority Data
Apr. 27, 2023 (CN) 202310479401.9

(51) Int. Cl. G06N 10/70; G06N 3/0455; G06N 3/0464; G06N 10/20

(52) U.S. Cl. CPC G06N 10/70; G06N 3/0455; G06N 3/0464; G06N 10/20

(57) ABSTRACT

The present disclosure relates to the field of artificial intelligence (AI) and quantum technologies, and provides a quantum error correction hardware decoder and a chip. The quantum error correction hardware decoder includes: a memory storing instructions, a neural network processing unit, and a processor in communication with the memory and the neural network processing unit; and wherein, when the processor executes the instructions, the processor is configured to cause the quantum error correction decoder to: obtain error syndrome information for an error syndrome measured due to an error occurring in a quantum circuit, decode, by the neural network processing unit, the error syndrome information based on a neural network model to obtain an output result of the neural network model, and determine error information based on the output result, the error information indicating a qubit in which an error occurs in the quantum circuit and a corresponding error type.

### RELATED APPLICATION

This application is a continuation application of PCT Patent Application No. PCT/CN2023/132891, filed on Nov. 21, 2023, which claims priority to Chinese Patent Application No. 202310479401.9, filed on Apr. 27, 2023, both of which are incorporated herein by reference in their entireties.

### FIELD OF THE TECHNOLOGY

Embodiments of the present disclosure relate to the field of artificial intelligence (AI) and quantum technologies, and in particular, to a quantum error correction hardware decoder and a chip.

### BACKGROUND OF THE DISCLOSURE

All operational processes in real quantum computation (QC), including quantum gates and quantum measurements, are accompanied by noise. In other words, even a circuit for performing quantum error correction inherently contains noise. Fault-tolerant quantum error correction (FTQEC) refers to performing error correction through an error correction circuit with noise after the error correction circuit is ingeniously designed. A purpose of correcting an error and preventing the error from spreading over time can still be achieved through the FTQEC.

For the FTQEC, corresponding error syndrome information is obtained by performing syndrome measurement on a quantum circuit, and then the error syndrome information is decoded to determine a qubit in which an error occurs in the quantum circuit and a corresponding error type. In the related art, a solution of decoding error syndrome information based on a neural network model is provided. The error syndrome information of the quantum circuit is inputted to the neural network model. The neural network model decodes the foregoing error syndrome information to obtain an output result of the neural network model. Then, a qubit in the quantum circuit where an error occurs and a corresponding error type may be further determined based on the output result.

Currently, in the decoding solution based on the neural network model, hardware implementation thereof still needs further study.

### SUMMARY

Embodiments of the present disclosure provide a quantum error correction hardware decoder and a chip. The technical solutions are as follows.

The present disclosure describes a quantum error correction decoder for decoding error syndrome information of a quantum circuit, the quantum error correction decoder comprising: a memory storing instructions, a neural network processing unit, and a processor in communication with the memory and the neural network processing unit; and wherein, when the processor executes the instructions, the processor is configured to cause the quantum error correction decoder to: obtain error syndrome information for an error syndrome measured due to an error occurring in a quantum circuit, decode, by the neural network processing unit, the error syndrome information of the quantum circuit based on a neural network model to obtain an output result of the neural network model, and determine error information based on the output result of the neural network model, the error information indicating a qubit in which an error occurs in the quantum circuit and a corresponding error type.

According to one aspect of the embodiments of the present disclosure, a quantum error correction hardware decoder is provided. The quantum error correction hardware decoder includes an instruction memory, a control unit, at least one neural network processing unit, and an error merging and searching unit.

The instruction memory is configured to store a computer instruction.

The control unit is configured to read the computer instruction from the instruction memory and control the at least one neural network processing unit based on the computer instruction.

The at least one neural network processing unit is configured to decode error syndrome information of a quantum circuit based on a neural network model in response to control of the control unit, to obtain an output result of the neural network model, the error syndrome information referring to an error syndrome measured due to an error occurring in the quantum circuit.

The error merging and searching unit is configured to determine error information based on the output result, the error information being configured for indicating a qubit in which an error occurs in the quantum circuit and a corresponding error type.

According to one aspect of the embodiments of the present disclosure, a chip is provided. The chip has the foregoing quantum error correction hardware decoder deployed thereon.

The technical solutions provided in the embodiments of the present disclosure include at least the following beneficial effects.

A hardware implementation architecture of a quantum error correction decoding algorithm based on a neural network is provided. The hardware architecture is a programmable architecture, and a computer instruction for implementing the decoding algorithm may be prestored in the instruction memory. In a real-time decoding process, the control unit reads the foregoing computer instruction, and controls, based on the computer instruction, the neural network processing unit to decode the error syndrome information of the quantum circuit based on the neural network model, to finally obtain the error information. The foregoing hardware decoding architecture can efficiently run the quantum error correction decoding algorithm based on the neural network model, thereby fully reducing a decoding delay while ensuring decoding performance. In addition, in the foregoing hardware decoding architecture, a quantity of neural network processing units and a quantity of arithmetical units (AU) included in the neural network processing units may be designed and extended based on an actual requirement. Therefore, the hardware decoding architecture provided in the present disclosure has good scalability and flexibility.

### BRIEF DESCRIPTION OF THE DRAWINGS

FIG. 1 is a schematic diagram of a rotating surface code according to an embodiment of the present disclosure.

FIG. 2 is a schematic diagram of an application scenario of a solution according to an embodiment of the present disclosure.

FIG. 3 is a schematic diagram of an error correction decoding process involved in an application scenario of the solution shown in FIG. 2.

FIG. 4 is a schematic architectural diagram of a quantum error correction hardware decoder according to an embodiment of the present disclosure.

FIG. 5 is a schematic diagram of a quantum error correction hardware decoder according to an embodiment of the present disclosure.

FIG. 6 is a schematic diagram of a prefetching mechanism in an adder tree according to an embodiment of the present disclosure.

FIG. 7 is a schematic diagram of a multi-core architecture according to an embodiment of the present disclosure.

FIG. 8 is a schematic diagram of resource consumption of a programmable decoder and a specific network architecture according to an embodiment of the present disclosure.

### DESCRIPTION OF EMBODIMENTS

To make objectives, technical solutions, and advantages of the present disclosure clearer, implementations of the present disclosure are described in further detail with reference to drawings.

Before embodiments of the present disclosure are described, some terms in the present disclosure are first defined and described.

1. Quantum computation (QC): It is a manner to quickly accomplish a specific computational task through superposition and entanglement properties of a quantum state.

2. Quantum error correction (QEC) code: It is a manner of mapping a quantum state into subspace in Hilbert space of a many-body quantum system for encoding. Quantum noise migrates an encoded quantum state to another subspace. By continuously observing space in which a quantum state is located (syndrome extraction), an encoded quantum state can be not interfered with while evaluating and correcting the quantum noise, thereby protecting the encoded quantum state from the interference of the quantum noise. Specifically, a [[n, k, d]] quantum error-correcting code represents encoding k logical qubits in n physical qubits, and is configured for correcting any └(d−1)/2┘ errors that occur on any single qubit.

3. Data quantum state: It is a quantum state of a data qubit configured for storing quantum information during QC.

4. Stabilizer generator: It is also referred to as a parity operator. Occurrence of quantum noise (error) changes eigenvalues of some stabilizer generators, so that quantum error correction can be performed based on the information.

5. Stabilizer group: A stabilizer group is a group generated by stabilizer generators. For example, an Abelian group generated by stabilizer generators is referred to as a stabilizer generator group. If k stabilizer generators exist, a stabilizer group includes 2^{k} elements, and is an abelian group.

6. Error syndrome: An eigenvalue of a stabilizer generator is 0 when an error does not exist. When the quantum noise occurs, eigenvalues of stabilizer generators (parity check operators) of some error correction codes that are prone to errors become 1. A bit string formed by syndrome bits of 0 and 1 is referred to as an error syndrome.

7. Syndrome measurement: It is measurement needs to be performed to collect the error syndrome. In order not to destroy information on the data qubit, the syndrome measurement is performed on an auxiliary qubit.

8. Quantity of rounds of syndrome measurement: Measurement also includes noise. To be fault tolerant to the measurement process, a plurality of rounds of measurement need to be repeatedly performed and all collected error syndromes are configured for decoding. The quantity of rounds of syndrome measurement may be represented by T.

9. Topological quantum error correction code (topological quantum code): It is a special type of quantum error correction code. Qubits of the type of error correction code are distributed on a grid array having a dimension greater than 2. The grid forms a high-dimensional discrete manifold structure. In this case, a stabilizer generator of the error correction code is defined on geometrically neighboring and finite qubits, and therefore is geometrically localized and easy to be measured physically. Qubits acting on logical operators of the type of error correction codes form a type of topological non-trivial geometrical object on a manifold of a grid array.

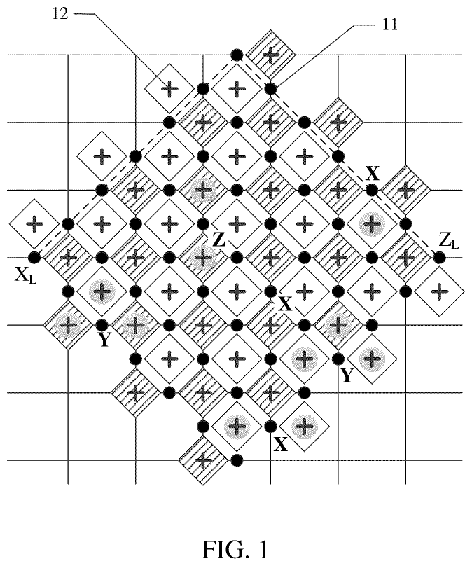

10. Surface code: The surface code is a type of topological quantum error correction code defined on a two-dimensional (2D) manifold. The stabilizer generator thereof is usually supported by 4 qubits (supported by 2 qubits at a boundary), and the logic operator is a non-mediocre chain crossing an array in a strip form. A specific 2D structure (7×7, including 49 data qubits and 48 auxiliary qubits, and a total of 97 physical qubits, which can correct any error occurring on two qubits) of a surface code is shown in FIG. 1. Black dots 11 represent data qubits configured for QC, and crosses 12 represent the auxiliary qubits. The auxiliary qubit is initially prepared in a state of |0 [symbol] or |+ [symbol] . Square filled with oblique lines and square filled with white represent two different types of stabilizer generators, which are respectively configured to detect a Z-error and an X-error.

11. Surface code scale L: It is a quarter of the circumference of a surface code array. The surface code array L=7 in FIG. 1, which includes 49 data qubits and 48 auxiliary qubits, and a total of 97 physical qubits.

12. X-error and Z-error: They are randomly generated Pauli-X and Pauli-Z evolution errors for a quantum state of a physical qubit. According to the quantum error correction theory, if an error correction code may correct an X-error and a Z-error, the error correction code may correct any error that occurs in a single qubit.

13. Fault-tolerant quantum error correction (FTQEC): All operational processes in real QC, including quantum gates and quantum measurements, are accompanied by noise. In other words, even a circuit itself configured for performing quantum error correction also includes noise. FTQEC refers to performing error correction by using an error correction circuit with noise after an error correction circuit is ingeniously designed, so as to correct an error and prevent the error from spreading with time.

14. Fault-tolerant quantum computation (FTQC): In a process of QC, any physical operation carries noises, including a quantum error correction circuit and measurement of a qubit. If it is assumed that classic operations (such as input of an instruction and decoding of an error correction code) do not include noise, the FTQC is a technical solution in which a quantum error correction solution is properly designed, and a particular manner of a quantum gate operation is performed on an encoded logic quantum state, to ensure that an error can be effectively controlled and corrected in a process of using a qubit carrying noise to perform the QC.

15. Physical qubit: It is a qubit implemented through an actual physical device.

16. Logical qubit: It is a mathematical degree of freedom in a Hilbort subspace defined by the error correction code. Descriptions of a quantum state thereof are usually entangled in a plurality of bodies, and generally are 2D subspace of a plurality of physical qubits together with a Hilbort space. FTQC needs to run on a logical qubit protected by an error correction code.

17. Quantum gate/circuit: It is a quantum gate/circuit acting on a physical qubit.

18. Threshold theorem: For a QC solution satisfying a requirement of fault-tolerant QC, when error rates of all operations fall below a specific threshold, a better error correction code, more qubits, and more quantum operations may be configured for enabling accuracy of computation to arbitrarily approximates to 1. Moreover, the additional resource overheads are negligible, compared to exponential acceleration of the QC.

19. Neural network: An artificial neural network is an adaptive nonlinear dynamic system formed by a large number of simple basic elements, namely, neurons, that are connected to each other. Each neuron has relatively simple structure and function, but system behaviors generated by a large number of neuron combinations are very complex, and in principle, any function can be expressed.

20. Convolutional Neural Network (CNN): It is a kind of feedforward neural network which includes convolutional computation and has depth structure. A convolutional layer is a core cornerstone of a CNN, that is, a discrete 2D or three-dimensional (3D) filter (also referred to as a convolution kernel, which is respectively a 2D or 3D matrix) performs a convolution operation on a 2D or 3D data lattice.

21. Field Programmable Gate Array (FPGA) chip: It is a product of further development based on a programmable device such as a programmable array logic (PAL) or a generic array logic (GAL). It appears as a semi-custom circuit in the field of application-specific integrated circuits (ASIC), solving the shortcomings of custom circuits and overcoming the shortcomings of the limited number of original programmable devices.

22. ASIC: It is an integrated circuit designed and manufactured to meet specific user requirements and needs of specific electronic systems. An ASIC design by using a complex programmable logic device (CPLD) and an FPGA is one of the most popular manners. A common feature of the CPLD is that the CPLD and the FPGA both have a user field programmable feature, and support a boundary scan technology. However, the CPLD and the FPGA have respective features in terms of an integration degree, a speed, and a programming manner.

23. Single flux quantity (SFQ) circuit: It is also referred to as a rapid single flux quantum (RSFQ) circuit, is a circuit formed by Josephson junctions (JJ), and represents “1” and “0” with presence or absence of a magnetic flux quantum. In a circuit, an “X” is configured for representing a Josephson junction. An SFQ includes an upper superconductor layer, a lower superconductor layer, and a very thin intermediate insulator layer. It may be configured for digital logic calculation.

24. Neural network model quantization: quantization is to compress an original network by reducing a quantity of bits required for representing each weight. A neural network model usually occupies a large storage space. If the neural network algorithm needs to be implemented on a hardware chip, a large amount of precious on-chip storage space and on-chip registers and traces are occupied, thereby seriously affecting a calculation speed. Because these parameters are floating-point numbers, an ordinary compression algorithm cannot effectively process this case. If calculation may be performed by using another simple value type (for example, fixed-point calculation) inside the model without affecting accuracy of the model, consumed hardware calculation resources (including an arithmetical unit (AU) and a storage unit of hardware) are greatly reduced. For an algorithm operating chip of a real-time feedback system, the quantization algorithm increases a calculation amount per unit time and reduces a delay of a decoding algorithm.

25. Multiply Accumulate (MAC) operation: It is a special operation is performed in a digital signal processor or some microprocessors. A hardware circuit unit implementing the operation is referred to as a “multiplier accumulator” or a “multiply accumulator”. An operation of the operation is adding a product result of multiplication and a value of an accumulator, and then storing the product result and the value in the accumulator.

26. Low-voltage differential signaling (LVDS): It is an electrical standard for a low-voltage differential signal, and is a method for serially transmitting data through a differential signal. Physical implementation is usually to use a twisted pair, so that high-speed transmission can be performed at a relatively low voltage. The LVDS is merely a specification of a physical layer, and does not relate to a communication method of a protocol layer, and the like. Therefore, the LVDS has a very low delay.

27. Given any Pauli operator P and a generator S of a stabilizer group of an error correction code C (a rotating surface code is used as an example in the present disclosure, and any topology error correction code may be defined in a similar manner), the Pauli operator P acting on a physical qubit supporting an error correction code may be disassembled into:

P=L(P)T(S(P))
where S(P) is a part of generator anti-commuting with P (also referred to as a syndrome of Pauli operator P) in S, and S(P) may be regarded as a bit array formed by 0 and 1. T(S(P)) is a Pauli operator generated by mapping based on the part of the generator. In quantum mechanics, if an operator F and an operator G satisfy that FG=GF, the operator F commutes with operator G. If the operator F and the operator G satisfy that FG=−GF, the operator F anti-commutes with the operator G. T(S(P)) is in one-to-one correspondence with S(P), which is referred to a simple representation of P. For the rotating surface code, the simple representation may be geometrically defined as a Pauli operator having a smallest distance between a syndrome point and a boundary and anti-commuting with P. A class-X Pauli operator is a Pauli operator having a smallest distance between a syndrome point a and the boundary and anti-commuting with P. A class-Z Pauli operator is a Pauli operator having a smallest distance between a syndrome point b and the boundary and anti-commuting with P. Generally, the topology error correction codes may have similar simple representation mappings.

L (P) is a specific operator (the operator is fixed once selected) in a logic class of an error correction code to which P belongs. If another Pauli operator P′ is considered, similar decomposition exists.

P′=L(P′)T(S(P′))

If S(P′)=S(P), and L(P′) and L(P) belong to the same logic type, P′ and P differ in only one element of a stabilizer group. In other words, they have equivalent meaning in respect of error correction. For any Pauli operator P, it may be defined that:

P_{c}=L_{c}(P)T(S(P))

where L_{c}(P) is a fixed representative element of a logical class to which L(P) belongs. P_{c} is referred to as a regular representation of P, and L_{c}(P)T(S(P)) is referred to as a regular representation of P. All Pauli operators are converted to the equivalent regular representations thereof. In this way, unnecessary diversity of the Pauli operator is greatly limited. Especially, when the Pauli operator is selected as an output of a model, difficulty in model training is greatly reduced, thereby improving a convergence speed of a training process.

The technical solution of the present disclosure relates to the field of quantum technology and artificial intelligence (AI) technology. AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning (ML)/deep learning.

ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstration.

With the research and progress of AI technologies, the AI technology has been researched and applied in many fields, such as a common smart home, a smart wearable device, a virtual assistant, a smart speaker, smart marketing, unmanned driving, automatic driving, an unmanned aerial vehicle, a robot, smart medical care, smart customer service, and the like. It is believed that with the development of technology, the AI technology is applicable in more fields and play an increasingly important value.

The solutions provided in the embodiments of the present disclosure relate to the application of ML technologies of AI in the field of quantum technologies, and specifically relates to the application of ML technologies in the decoding algorithm of quantum error correction code, which are specifically described by using the following embodiments.

Because a qubit is highly susceptible to noise, it is not practical to directly implement QC on a physical qubit from the perspective of current technologies. The development of the quantum error correction code and the FTQC technology, in principle, provides a possibility of implementing arbitrary-precision QC on noisy qubits. Generally, measurement on a stabilizer generator of quantum error correction code (also referred to as parity check on a qubit) needs to introduce a long-distance quantum gate, and additionally needs to prepare complex quantum auxiliary states by using additional qubits to implement fault-tolerant error correction. Due to a limitation of an existing experimental manner, people are not able to implement a high-precision long-distance quantum gate, or prepare a complex quantum auxiliary state. The use of a surface code as a solution for FTQEC and FTQC eliminates the needs of using the long-distance quantum gate and preparing the complex quantum auxiliary state. Therefore, it is considered as a solution highly possible to realize a universal fault-tolerant quantum computer using the existing technology.

As an error correction code, when an error occurs, error syndromes may be obtained by performing a parity check. Then, based on these syndromes, a specific decoding algorithm for the error correction code is needed to determine a position and a type of the error (whether the error is an X-error, a Z-error, or a combination of both, i.e., a Y-error). For the surface code, the error and the error syndrome have specific spatial positions. When a syndrome is caused by the error, the eigenvalue of an auxiliary qubit at a corresponding position is 1 (which may be considered as that a dot particle appears at the position). When the error does not exist, the eigenvalue of the auxiliary qubit at the corresponding position is 0. In this case, decoding may be summarized as the following problems. If a space digit array (2D or 3D, with a value being 0 or 1) is given, based on a particular error model, to be specific, an error probability distribution occurring on a qubit, it is reasoned about which qubit may have an error at the largest, and a specific error type, and error correction is performed based on the reasoning result.

It has been described above that corresponding error information, for example, including a position and a type of the error, may be obtained by decoding the error syndrome information through the decoding algorithm of the error correction code. The present disclosure mainly focuses on a hardware implementation architecture of a quantum error correction decoding algorithm based on the neural network, and provides a neural network quantum error correction hardware decoder based on a programmable architecture. The quantum error correction hardware decoder in the present disclosure refers to a hardware architecture implemented by deploying the decoding algorithm related to quantum error correction on corresponding hardware resources, and may be applied to a real-time quantum error correction scenario.

The quality of performance of a quantum error correction hardware decoder may be measured according to the following several performance indicators: decoding performance, a decoding delay, scalability, and flexibility.

Decoding performance (precision): It is measured by a rate of errors occurring in logical qubits after decoding and error correction by using a specific noise model. For the same physical qubit error rate, a lower logical error rate indicates better decoding performance. For a hardware decoder, an upper limit of decoding performance of the hardware decoder is determined by the decoding algorithm used by the hardware decoder. However, in a hardware implementation process, specific hardware resources may limit algorithm implementation (for example, quantization of a neural network), which causes a precision loss.

Decoding delay: A life time of a superconductive qubit is approximately 150 microseconds in a relatively good process. However, a system is in an idle state in a decoding process, and errors gradually accumulate as time increases. Theoretically, it is required that an entire error correction process consumes less than 1/1000 to 1/100 of a life time of the superconductive qubit. In other words, an entire error correction delay needs to be less than approximately 1.5 microseconds (μs). Otherwise, an error occurrence rate may exceed an error correction capability of a surface code. Targeted optimization of a hardware decoder has a vital function in reaching the delay target.

Scalability: It is hoped that resource consumption of a hardware decoder gently increases as a surface code scale L increases. Otherwise, a decoder with a larger L cannot be implemented. It means that a used decoding algorithm has relatively low algorithm complexity first, and then hardware architecture optimization is needed to further reduce resource consumption.

Flexibility: In an actual application scenario, the hardware decoder needs to adapt to various different environment configurations, including different noise levels, surface code distances, error correction code forms, or the like. Therefore, it is hoped that the decoder can be flexibly configured, and an experiment is performed by reconfiguring the decoder frequently to find an optimal design in different scenarios. When an ASIC is configured to implement the hardware decoder, the requirement becomes especially critical, because a redesign-deployment procedure of the ASIC is relatively long, costs are huge, and is impractical in an engineering and implementation application scenario.

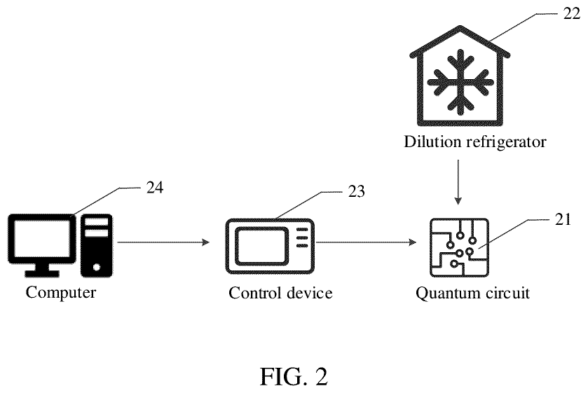

FIG. 2 is a schematic diagram of an application scenario of a solution according to an embodiment of the present disclosure. As shown in FIG. 2, the application scenario may be a superconducting QC platform. The application scenario includes a quantum circuit 21, a dilution refrigerator 22, a control device 23, and a computer 24.

The quantum circuit 21 is a circuit that acts on a physical qubit. The quantum circuit 21 may be implemented as a quantum chip, such as a superconducting quantum chip near absolute zero. The dilution refrigerator 22 is configured to provide an absolute zero environment for the superconducting quantum chip.

The control device 23 is configured to control the quantum circuit 21, and the computer 24 is configured to control the control device 23. For example, a written quantum program is compiled into instructions by software in the computer 24, and the instructions are transmitted to the control device 23 (such as an electronic/microwave control system). The control device 23 converts the instructions into electronic/microwave control signals and inputs the signals to the dilution refrigerator 22 to control a superconducting qubit at 10 mK. The reading process is reversed.

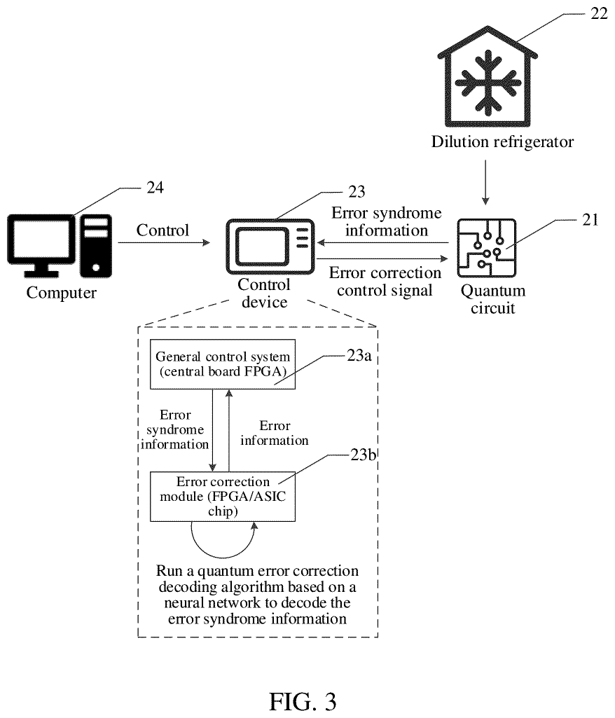

The present disclosure provides an optimized quantum algorithm suitable for real-time error correction of the superconducting qubit. As shown in FIG. 3, the real-time quantum fault-tolerant error-correction algorithm needs to be combined with a control device 23 (for example, the decoding algorithm is integrated into an electronic/microwave control system). After a general control system 23a (for example, a central board FPGA) of the control device 23 reads error syndrome information from a quantum circuit 21, the general control system 23a transmits an error correction instruction to an error correction module 23b of the control device 23. The error correction instruction includes the error syndrome information of the foregoing quantum circuit 21. The error correction module 23b may be an FPGA chip or an ASIC chip. The error correction module 23b runs a quantum error correction decoding algorithm based on a neural network, decodes the error syndrome information, converts error information obtained through decoding into an error correction control signal in real time, and transmits the error correction control signal to the quantum circuit 21 for error correction.

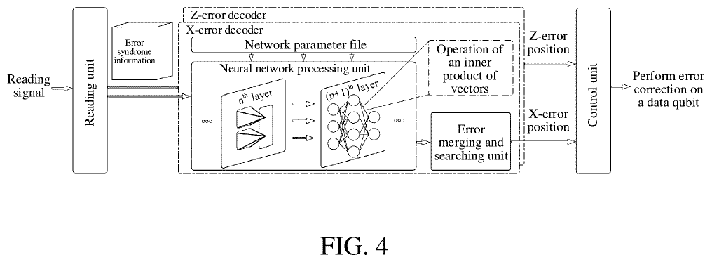

FIG. 4 is a schematic architectural diagram of a quantum error correction hardware decoder according to an embodiment of the present disclosure.

In some embodiments, error syndrome measurement is performed on a quantum circuit through a quantum error correction code, to obtain corresponding error syndrome information. The error syndrome information is a data array formed by eigenvalues of stabilizer generators of the quantum error correction code. In some embodiments, the error syndrome information is a 2D or 3D data array formed by 0 and 1. For example, the eigenvalue of the stabilizer generator is 0 when an error does not exist; and the eigenvalue of the stabilizer generator is 1 when an error exists. An example in which the quantum error correction code is a surface code is used. For the surface code, the error and the error syndrome have specific spatial positions. When a syndrome is caused by the error, the eigenvalue of an auxiliary qubit at a corresponding position is 1 (which may be considered as that a dot particle appears at the position). When the error does not exist, the eigenvalue of the auxiliary qubit at the corresponding position is 0. Therefore, for the surface code, if an error in an error correction process itself is not considered (in other words, if a measurement process is perfect, and a syndrome is referred to as a perfect syndrome), the error syndrome information may be considered as the 2D data array formed by 0 and 1. In some embodiments, if a plurality of rounds of syndrome measurement is performed on the quantum circuit, each round of syndrome measurement may obtain error syndrome information in a form of the 2D data array, and a plurality of rounds of syndrome measurement may obtain error syndrome information in a form of the 3D data array.

In some embodiments, for a surface code whose scale is L, T (where T is greater than L) rounds of measurement need to be performed to ensure fault tolerance to a measurement error. Each round of measurement generates a corresponding one-bit result for each auxiliary qubit. Results of the plurality of rounds of measurement are combined into the 3D data array formed by 0 and 1. The 3D data array is the error syndrome information of the quantum circuit.

In some embodiments, the quantum error correction hardware decoder obtains the error syndrome information of the quantum circuit through a general control system. For example, the general control system instructs, through an error correction instruction, the quantum error correction hardware decoder to start performing quantum error correction. Exemplarily, the error correction instruction includes the error syndrome information of the quantum circuit. Alternatively, the quantum error correction hardware decoder reads the error syndrome information from the general control system in response to the received error correction instruction. In other words, the error syndrome information of the quantum circuit is transmitted to the quantum error correction hardware decoder, and the quantum error correction hardware decoder decodes the error syndrome information, to finally obtain the error information of the quantum circuit. The error information is configured for indicating the qubit in which an error occurs in the quantum circuit and the corresponding error type. The error type includes at least one of the following: an X-error and a Z-error.

In some embodiments, error information of different error types is obtained by decoding the error syndrome information by different quantum error correction decoders. For example, 2 quantum error correction hardware decoders are designed, which are denoted as a first quantum error correction hardware decoder and a second quantum error correction hardware decoder. The first quantum error correction hardware decoder (i.e., an X-error decoder in FIG. 4) is configured to perform decoding to obtain class-X error information. The class-X error information is configured for indicating a qubit in which the X-error occurs in the quantum circuit. The second quantum error correction hardware decoder (i.e., a Z-error decoder in FIG. 4) is configured to perform decoding to obtain class-Z error information. The class-Z error information is configured for indicating a qubit in which the Z-error occurs in the quantum circuit.

In a possible implementation, the error syndrome information is decomposed into two parts, namely, class-X error syndrome information and class-Z error syndrome information, and the two parts are respectively inputted to the first quantum error correction hardware decoder and the second quantum error correction hardware decoder. The first quantum error correction hardware decoder decodes the class-X error syndrome information to obtain the class-X error information. The second quantum error correction hardware decoder decodes the class-Z error syndrome information to obtain the class-Z error information. This helps reduce computation complexity of the decoder.

In another possible implementation, inputs of the first quantum error correction hardware decoder and the second quantum error correction hardware decoder are both error syndrome information. The class-X error syndrome information and the class-Z error syndrome information are not distinguished, but all syndrome bits are combined together to decode the X-error and the Z-error simultaneously. Since the X-error and the Z-error are associated with each other, in the foregoing manner, all the syndrome bits are combined, so that positions in which the X-error and the Z-error occur can be determined more accurately.

In some other embodiments, error information of different error types is obtained by decoding the error syndrome information by the same quantum error correction decoder. For example, only one quantum error correction hardware decoder is designed. The error syndrome information is inputted to the quantum error correction hardware decoder, and the quantum error correction hardware decoder decodes the error syndrome information to obtain error information. The error information includes a qubit in which an error occurs in the quantum circuit and a corresponding error type. In other words, a quantum error correction hardware decoder determines both the X-error and the Z error.

The quantum error correction hardware decoder decodes the error syndrome information based on a neural network model. The neural network model is an AI model constructed based on a neural network. A network parameter file needs to be stored in the quantum error correction hardware decoder. The network parameter file has parameters of the neural network model stored therein, for example, including a weight parameter and a bias parameter of the neural network model. A large number of parameters need to be used in a calculation process of the neural network model. The parameters are trained in advance on software and loaded into the network parameter file before error correction starts. The parameters of the neural network model are divided into different groups to be loaded into an AU, so that the decoder is required to quickly switch each group of parameters in a real-time decoding process.

Therefore, in the present disclosure, on-chip storage is preferably selected to store the network parameter file, to avoid a relatively large reading delay for off-chip storage. The entire network parameter file is divided into two parts based on different data structures. One part is configured to store the weight parameter (also referred to as a weight matrix), and the other part is configured to store the bias parameter (also referred to as a bias vector). The parameters are originally floating-point numbers, but this causes a complex multiplication operation and consumes a large amount of storage space. To improve storage and calculation efficiency, in the present disclosure, the parameters are quantized into 8-bit signed fixed-point numbers and implemented on an FPGA. Implementation of the AU and a data file are simplified through non-saturation quantization, which causes only negligible loss of accuracy. Certainly, the foregoing parameters in a form of the floating-point number may also be quantized into signed fixed-point numbers having another quantity of bits. This may be comprehensively considered based on a plurality of aspects such as an operation capability, a precision requirement, and an algorithm complexity of the decoder, which is not limited in the embodiments of the present disclosure.

A main hardware unit responsible for neural network operation in the quantum error correction hardware decoder is a neural network processing unit (or referred to as a neural network processing engine (NPE)). One or more neural network processing units may be arranged. Each neural network processing unit may include a plurality of AUs. In some embodiments, the neural network model may be constructed based on a 3D CNN and a fully connected neural network (FCNN or FCN). In the neural network processing unit, most AUs perform a similar operation of an inner product of vectors, which may be expressed as the following formula.

$${s}_{j}^{n} = {\sum }_{i} {W}_{j , i}^{n} \cdot {y}_{i}^{n}$$

$${y}_{j}^{n + 1} = A ( {s}_{j}^{n} + {b}_{j}^{n} )$$

yⁿ⁺¹ represents output data of an n^{th} layer of the neural network model, which is also input data of an (n+1)^{th} layer, n being a positive integer. W_{j,i}ⁿ is a weight coefficient corresponding to a computing node in a j^{th} row and an i^{th} column of an n^{th} layer, yᵢⁿ is an i^{th} element of an input data vector in the n^{th} layer, sⱼⁿ represents a calculation result obtained by performing weighted summation on the input data vector in the n^{th} layer based on a weight coefficient corresponding to a computing node in the j^{th} row of a coefficient matrix of the n^{th} layer, bⱼⁿ is a bias coefficient of the j^{th} row of the n^{th} layer, A represents a nonlinear function, and yⱼⁿ⁺¹ represents output data of the j^{th} row in the n^{th} layer. Since the bias vectors are used only once in each iteration, the bias vectors may also be stored in a series of simple registers. The multiply-accumulate operation of the neural network processing unit occupies most computing resources in the entire decoder.

The quantum error correction hardware decoder further includes an error merging and searching unit, which is configured to determine error information based on an output result of the neural network model. An example in which the X-error and the Z-error are separately decoded is used. The first quantum error correction hardware decoder and the second quantum error correction hardware decoder each generate a decoding result of a bit having a length of

$$\frac{{L}^{2} - 1}{2} ,$$

i.e., a combination of errors that may occur, L being a surface code scale. This decoding result is used as an address to search a look up table (LUT). Correspondingly, the LUT also includes a quantity

$$\frac{{L}^{2} - 1}{2}$$

of entries. A magnitude of each entry is L², which corresponds to a quantity of data qubits. Therefore, memory consumption of the LUT is

$$2 \times \frac{{L}^{2} - 1}{2} \times {L}^{2} = {L}^{4} - {L}^{2} .$$

During searching, content of the LUT corresponding to each non-zero position in the decoding result is extracted to perform an exclusive or operation, and an obtained final result is a position of a data qubit in which the error occurs. Therefore, the quantity and the magnitude of entries in the LUT may be easily calculated. For the surface code having the scale L, the LUT consumes memory of L⁴−L² bits. This has a relatively low storage requirement, and a predictable surface code scale may be easily implemented through the LUT. Finally, the error information is transmitted to a control unit to generate an error correction control signal of the data qubit.

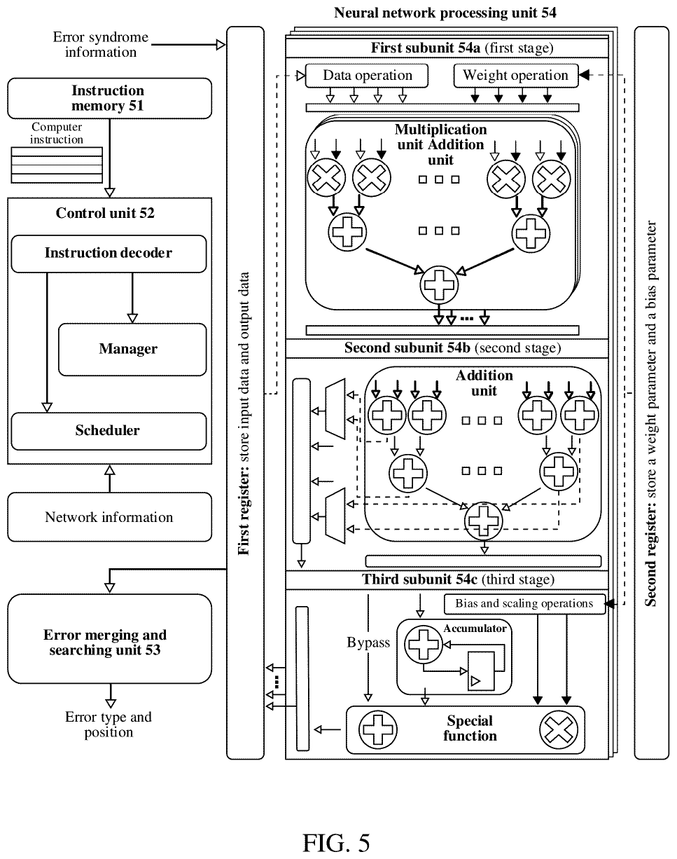

FIG. 5 is a schematic diagram of a quantum error correction hardware decoder according to an embodiment of the present disclosure. The quantum error correction hardware decoder includes an instruction memory 51, a control unit 52, at least one neural network processing unit 54, and an error merging and searching unit 53.

The instruction memory 51 is configured to store a computer instruction.

The control unit 52 is configured to read the computer instruction from the instruction memory 51 and control the at least one neural network processing unit 54 based on the computer instruction. The at least one neural network processing unit 54 is configured to decode error syndrome information of a quantum circuit based on a neural network model in response to control of the control unit 52, to obtain an output result of the neural network model, the error syndrome information referring to an error syndrome obtained by performing error measurement on the quantum circuit.

The error merging and searching unit 53 is configured to determine error information based on the output result, the error information being configured for indicating a qubit in which an error occurs in the quantum circuit and a corresponding error type.

The control unit 52 is mainly responsible for instruction scheduling of operations in an entire decoding process. Before the real-time error-correction decoding starts, a series of assembly code (or referred to as computer instructions) that describes a decoding algorithm may be generated through a compiler, and loaded into the instruction memory 51. The foregoing assembly code is configured for implementing a processing procedure of the entire decoding algorithm, so as to control the at least one neural network processing unit 54 to decode the error syndrome information of the quantum circuit based on the neural network model, to obtain an output result of the neural network model. After the real-time error correction decoding starts, the control unit 52 reads the computer instruction from the instruction memory 51, and performs decoding and execution. In the foregoing manner, the quantum error correction hardware decoder provided in this embodiment of the present disclosure is programmable, and corresponding code may be flexibly written based on the decoding algorithm, which helps improve universality of the quantum error correction hardware decoder for different error correction algorithms.

In some embodiments, the control unit 52 receives the error correction instruction transmitted by the general control system, and obtains the error syndrome information of the quantum circuit from the error correction instruction. The control unit 52 transmits the error syndrome information of the quantum circuit to the neural network model, so that the neural network model decodes the error syndrome information of the quantum circuit. In other words, the error syndrome information of the quantum circuit is used as input data of the neural network model. For a specific form of the error syndrome information of the quantum circuit, reference is made to the foregoing embodiments. Details are not described herein again.

Exemplarily, for a number of network layers of the neural network model, a function of each network layer is determined based on an actually used quantum error correction algorithm. For example, the neural network model is designed based on networks such as a 3D CNN, an FCNN, and a recurrent neural network (RNN). The neural network model is configured for a type of error that occurs during decoding based on error feature information. A model structure of the neural network model is not limited in the embodiments of the present disclosure.

In some embodiments, the decoding process of the neural network model is divided into n sub-processes performed in sequence, the neural network processing unit 54 being reused in different sub-processes, and n being an integer greater than 1. In some embodiments, the sub-processes included in the decoding process are obtained by dividing the decoding process. For example, the decoding process is divided into n sub-processes based on different functions of stages in the decoding process. For any sub-process of the n sub-processes, the sub-process is started to obtain the input data, and output data is obtained by processing the input sub-data during the sub-process. The output data is outputted after the sub-process ends.

The decoding process of the neural network model is a process of decoding the error syndrome information of the quantum circuit based on the neural network model, to obtain an output result of the neural network model. The decoding process may be understood as a classification process. In other words, encoding the error syndrome information to obtain the feature information, and decoding is performed based on the feature information to obtain a decoding result of the error syndrome information.

In some embodiments, the output result of the neural network model includes a plurality of decoding results. Exemplarily, the type of the decoding result includes at least one of the following. The error syndrome information includes a probability distribution of an error type, a representative element related to an error type, and a regular syndrome related to a type. The regular syndrome refers to a regular decomposition result of error syndrome information. For example, the plurality of decoding results includes a probability distribution that the error syndrome information separately belonging to each error type. For another example, the plurality of decoding results includes a representative element related to each error type and a regular syndrome related to each error type.

The output result of the neural network model is related to training data selected in the process of training the neural network. For example, if the neural network model is trained through the sample error syndrome information and the probability distribution of the error type, the output result after the trained neural network model processes the error syndrome information includes the probability distribution of the error type. For another example, if the neural network model is trained through the sample error syndrome information and the representative element related to the error type, the output result of processing the error syndrome information by the trained neural network model includes the probability distribution of the error type. A form of the output result of the neural network model is not limited in the present disclosure.

In some embodiments, the decoding process of the neural network model is divided based on the structure of the neural network model, to obtain n sub-processes performed in sequence. An (i+1)^{th} sub-process is performed after an i^{th} sub-process. In other words, the (i+1)^{th} sub-process starts to be performed after the i^{th} sub-process is completed, i being a positive integer less than or equal to n. Exemplarily, the neural network model has a 4-layer structure, including a first convolutional layer, a second convolutional layer, a third convolutional layer, and a fully connected layer successively connected in series. Input data of the first convolutional layer includes error syndrome information of the quantum circuit. A convolution operation is performed on error syndrome information of a sub-circuit through the first convolutional layer, to obtain output data of the first convolutional layer. Output data of the first convolutional layer is used as input data of the second convolutional layer. The second convolutional layer performs a convolution operation on the input data of the second convolutional layer, to obtain output data of the second convolutional layer. The output data of the second convolutional layer is used as input data of the third convolutional layer. The third convolutional layer performs a convolution operation on the input data of the third convolutional layer, to obtain output data of the third convolutional layer. The output data of the third convolutional layer is used as input data of the fully connected layer. The fully connected layer performs an operation of an inner product of vectors on the input data of the fully connected layer, to obtain the output result of the neural network model. Based on the structure of the foregoing neural network model, the decoding process of the neural network model may be divided into 4 sub-processes performed in sequence. A first sub-process is an operation process of the first convolutional layer, a second sub-process is an operation process of the second convolutional layer, a third sub-process is an operation process of the third convolutional layer, and a fourth sub-process is an operation process of the fully connected layer.

Different parameters of the neural network model may be used in different sub-processes. Continuously, at a start stage of a sub-process, the neural network processing unit 54 obtains a parameter of a neural network model that needs to be used in the sub-process. To improve a speed of obtaining the parameter of the neural network model that needs to be used in the sub-process, exemplarily, the parameter of the neural network model is stored in blocks in advance. For any parameter block, the parameter of the neural network model included in the parameter block is used in a sub-process. The parameter block may be understood as a parameter whose storage addresses are consecutive or whose storage addresses have a particular rule. These parameters need to be used in a same sub-process. In an example, at a stage at which a sub-process starts or is about to start, the quantum error correction hardware decoder may obtain, by reading parameters in the parameter block, all parameters needed in a process of performing the sub-process. For the specific operations of parameter reading, reference is made to the following embodiments.

Through the foregoing division, the neural network processing unit 54 can be multiplexed in different sub-processes. For example, the neural network processing unit 54 starts to perform from the first sub-process. After the first sub-process is completed, the neural network processing unit 54 starts to perform the second sub-process, and so on, until an n^{th} sub-process is completed. In this way, the output result of the neural network model can be obtained. The decoding process of the neural network model is divided into a plurality of sub-processes performed in sequence, and the neural network processing unit is reused in different sub-processes, so that a dedicated AU is not required to allocate to different network layers, which helps improve utilization of each AU in the decoder and reduces complexity and costs of hardware design of the decoder.

In some embodiments, each sub-process includes a first stage, a second stage, and a third stage. The first stage is configured for performing a multiply-accumulate operation on input data of the sub-process, to obtain at least one first calculation result. The second stage is configured for performing an addition operation on the at least one first calculation result, to obtain at least one second calculation result. The third stage is configured for obtaining output data of the sub-process based on the at least one second calculation result. The input data of the first sub-process in the n sub-processes includes the error syndrome information of the quantum circuit, and output data of a last sub-process (i.e., the n^{th} sub-process) in the n sub-processes includes the output result of the neural network model.

It may be learned from the foregoing description of the main operation process of the neural network model that the neural network model mainly involves a multiplication operation and an addition operation. Therefore, each sub-process is divided into 3 stages. The first stage may also be referred to as a multiply-accumulate stage, and is configured for performing a multiply-accumulate operation on input data of the sub-process, to obtain at least one first calculation result. For example, in the first stage, a multiplication operation is mainly performed to calculate W_{j,i}ⁿ·yᵢⁿ. Alternatively, some addition operations may be performed, and the foregoing product results are added. The second stage may also be referred to as an addition stage, and is configured for performing an addition operation on the at least one first calculation result obtained in the first stage, to obtain at least one second calculation result. The third stage is responsible for some final finishing operation and processing, and obtains output data of the sub-process based on the at least one second calculation result obtained in the second stage. A common feature of each sub-process is analyzed, and each sub-process is divided into the foregoing 3 stages, which cause the entire decoding algorithm process to be clearer. As a result, corresponding hardware is easy to deploy and implement.

For any one of the three stages that are performed in sequence included in the sub-process, the same type of operation needs to be performed in the same stage, a similar type of AU is used, and data transmission is stored between adjacent stages in time sequence. The sub-process is divided into a plurality of stages, so as to facilitate design of a layout of each AU that needs to be used in each stage on the neural network processing unit, and design of a trace between AUs. Based on the above, regularity of the AU in the neural network processing unit is helped improve, and performance of the neural network processing unit in a later period is helped extend, to support a larger surface code scale, which helps to improve capability of adapting the quantum error correction hardware decoder to different error correction cases.

In some embodiments, each sub-process is divided into the foregoing 3 stages. The neural network processing unit 54 includes a first subunit 54a, a second subunit 54b, and a third subunit 54c. The first subunit 54a includes at least one AU configured to perform the first stage. For example, the first subunit 54a includes one or more multiplication units. In some embodiments, the first subunit 54a further includes one or more addition units. The second subunit 54b includes at least one AU configured to perform the second stage. For example, the second subunit 54b includes one or more addition units. The third subunit 54c includes at least one AU configured to perform the third stage. For example, the third subunit 54c includes an adder. In some embodiments, the third subunit 54c further includes a register. The register and the adder are configured to cooperate to complete an accumulation operation.

A type of the AU included in the subunit is related to an operation that needs to be completed in a stage in which the subunit is configured to perform, which are not limited herein.

In this embodiment of the present disclosure, quantities of the multiplication unit and the addition unit included in the first subunit 54a are not specifically limited, which may be designed in combination with an actual requirement. For example, when the first subunit 54a includes 4 multiplication units, the first subunit supports parallel calculation of 4 groups of multiplication operations. When the first subunit 54a includes 8 multiplication units, the first subunit supports parallel calculation of 8 groups of multiplication operations. A larger quantity of multiplication units included in the first subunit 54a indicates a larger quantity of parallel multiplication operations supported by the first subunit. Correspondingly, the structure of the first subunit 54a is relatively more complex. In addition, the addition unit included in the first subunit 54a may have a tree structure, and adds product results obtained by the foregoing multiplication unit. In an actual application, a suitable quantity of multiplication units and addition units may be selected with reference to comprehensive consideration of a plurality of aspects such as complexity of an entire decoding algorithm, a decoding delay, and hardware complexity.

Operations that need to be performed in the stages are not completely the same, and a chronological relationship does not exist between each stage. Therefore, a stage is used as a minimum unit, and a corresponding AU is set for each stage, which not only can ensure normal decoding, but also helps avoid redundant AUs, thereby helping reduce hardware overhead of the quantum error correction hardware decoder.

In some embodiments, the first subunit 54a further includes a data operation unit and a weight operation unit. The data operation unit is configured to read the input data used in the first stage from a first register. The weight operation unit is configured to read a weight parameter of the neural network model used in the first stage from a second register. The input data and the weight parameter described above are transmitted to a corresponding multiplication unit for operation.

In some embodiments, the process in which the data operation unit reads the input data used in the first stage from the first register and the process in which the weight operation unit reads the weight parameter of the neural network model used in the first stage from the second register may be performed in parallel.

Exemplarily, the control unit 52 separately transmits a first computer instruction to the data operation unit and transmits a second computer instruction to the weight operation unit in a same clock cycle. Therefore, the data operation unit reads the input data used in the first stage from the first register based on the first computer instruction. The weight operation unit reads weight data used in the first stage from the second register based on the second computer instruction. By means of the setting, a time difference between the weight data and the input data arriving at the multiplication unit in the first subunit helps shorten time consumption in the first stage.

Certainly, the control unit 52 may separately transmit the first computer instruction and the second computer instruction in a same clock cycle or in different clock cycles, which is not limited in the present disclosure herein.

In some embodiments, a line connection exists between the data operation unit and the AU included in the first subunit 54a. The data operation unit transmits the input data to the computation unit through a line. A line connection exists between the weight operation unit and the AU included in the first subunit 54a, and the weight operation unit transmits the weight data to the AU through the line.

Considering that the neural network model usually processes multi-dimensional input data in a form of vector or a matrix, and different elements (which is understood as a value in the input data) in the vector or the matrix respectively correspond to different weight data, a trace connection exists between the data operation unit and the at least one AU included in the first subunit 54a, and the data operation unit transmits the foregoing elements to the corresponding AU through the trace.

Through the data operation unit and the weight operation unit, it can be ensured that the input data and the weight parameter are correctly provided to the corresponding multiplication unit for processing.

As shown in FIG. 5, the quantum error correction hardware decoder further includes the first register and the second register. The first register is configured to store input data used in a decoding process of the neural network model, and configured to store output data generated in the decoding process of the neural network mode. The second register is configured to store a weight parameter and a bias parameter of the neural network model.

In some embodiments, the first register stores the error syndrome information. Exemplarily, the first register obtains the error syndrome information from the error correction instruction and stores the error syndrome information. In each sub-process of the decoding process, the neural network processing unit may read data and parameters that need to be used in the sub-process from the foregoing 2 registers, and store the output data obtained in the sub-process into the first register for subsequent use after the sub-process is performed. By arranging the foregoing 2 registers, data and a parameter that are used in the decoding process are respectively stored, thereby ensuring data and parameter read/write efficiency.

In addition, the foregoing first subunit 54a has scalability. For example, quantities of the multiplication units and the addition units in the first subunit 54a may be increased as required, to support a larger surface code scale. In some embodiments, a quantity of the first subunits 54a may also be increased as required. For example, a plurality of first subunits 54a are arranged. The plurality of first subunits 54a may perform an operation that needs to be completed in the first stage in parallel, and finally integrate operation results of the plurality of first subunits 54a, to obtain the foregoing at least one first calculation result. In addition, in the first stage, the first subunit(s) 54a to be selected to perform an operation and the multiplication unit(s) and addition unit(s) to be selected to perform an operation may be specified in advance through the computer instruction stored in the instruction memory 51. The control unit 52 controls a corresponding first subunit 54a and a corresponding AU to perform a corresponding operation based on the computer instruction.

In this embodiment of the present disclosure, the quantity of the addition units included in the second subunit 54b is not specifically limited, which may be designed in combination with an actual requirement. In addition, the addition unit included in the second subunit 54b may have a tree structure, and performs addition on the at least one first calculation result. The quantity of the addition units included in the first subunit 54a and the second subunit 54b may be determined based on the quantity of the multiplication units included in the first subunit 54a. For example, when the quantity of the multiplication units included in the first subunit 54a is C, a required depth of an adder tree is log₂ C, and the quantity of the addition units included in the first subunit 54a and the second subunit 54b may be determined based on that the depth of the adder tree is log₂ C. For example, when the quantity of the multiplication units is 4, the depth of the adder tree is 2, and a total of 2+1=3 addition units is included. When the quantity of the multiplication units is 8, the depth of the adder tree is 3, and a total of 4+2+1=7 addition units are included. When the quantity of the multiplication units is 16, the depth of the adder tree is 4, and a total of 8+4+2+1=15 addition units is included. The rest can be deduced by analogy.

In some embodiments, the second subunit 54b further includes at least one multiplexer (for example, a module shown by a trapezoid in FIG. 5). the multiplexer is configured to prefetch calculation results of different depths in a corresponding AU tree (for example, the adder tree) in the second stage. The AU tree includes a plurality of AUs. The plurality of AUs has a hierarchical mechanism in the AU tree. For a first layer other than a lowest layer in the AU tree, input data of an AU at a first layer is from an AU at a second layer. For example, input data of an AU in the first layer is an operation result of at least one AU in the second layer. The second layer refers to a result of a layer that is adjacent to the first layer and is lower than the first layer in the AU tree. For example, the AU tree includes 4 levels, and levels are respectively as follows in descending order: a level 1, a level 2, a level 3, and a level 4. If the first level is the level 2, the second level is the level 1.

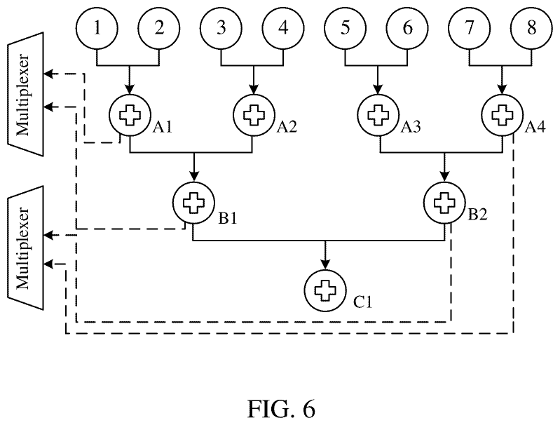

Considering that in the first stage, not all multiplication units need to be used each time, the quantity of multiplication operations can be flexibly configured through the prefetching mechanism. Exemplarily, as shown in FIG. 6, it is assumed that 8 multiplication units exist, which are correspondingly represented by circles numbered 1 to 8 in FIG. 6. Two operation results obtained by multiplication units numbered 1 and 2 are added through one addition unit A1, to obtain a summation result. Two operation results obtained by the multiplication units numbered 3 and 4 are added through one addition unit A2, to obtain a summation result. Two operation results obtained by the multiplication units numbered 5 and 6 are added through one addition unit A3, to obtain a summation result. Two operation results obtained by the multiplication units numbered 7 and 8 are added through one addition unit A4, to obtain a summation result. Further, the summation result obtained by the addition unit A1 and the addition unit A2 are added through one addition unit B1, to obtain a summation result. the summation result obtained by the addition unit A3 and the addition unit A4 are added through one addition unit B2, to obtain a summation result. the summation result obtained by the addition unit B1 and the addition unit B2 are added through one addition unit C1, to obtain a summation result. The addition units A1-A4, B1-B2, and C1 jointly form an adder tree. It is assumed that in some cases, only one addition unit needs to be used to add two values. For example, only an addition unit A1 needs to be used to add two operation results obtained by the multiplication units numbered 1 and 2. Alternatively, in some cases, only three addition units need to be used to add four values. For example, only the addition units A1, A2, and B1 need to be configured to add four operation results obtained by the multiplication units numbered 1-4. Therefore, the multiplexer may be arranged to prefetch calculation results of different depths in the adder tree, which helps to improve adaptability of the second subunit 54b for different operation scenarios, thereby improving flexibility and reducing a delay.

In addition, the foregoing second subunit 54b also has scalability. For example, a quantity of the addition units in the second subunit 54b may be increased as required, to support a larger surface code scale. In some embodiments, a quantity of the second subunits 54b may also be increased as required. For example, a plurality of second subunits 54b are arranged. The plurality of second subunits 54b may perform an operation that needs to be completed in the second stage in parallel, and finally integrate operation results of the plurality of second subunits 54b, to obtain the foregoing at least one second calculation result. In addition, in the second stage, the second subunit(s) 54b to be selected to perform an operation and addition unit(s) to be selected to perform an operation may be specified in advance through the computer instruction stored in the instruction memory 51. The control unit 52 controls a corresponding second subunit 54b and the AU to perform corresponding operation based on the computer instruction.

In this embodiment of the present disclosure, a specific type and quantity of AUs included in the third subunit 54c are not limited, and may be correspondingly designed based on an operation to be completed in the third stage. For example, when the addition operation between the second calculation result and a bias coefficient needs to be completed in the third stage, an addition unit needs to be provided in the third subunit 54c. For example, when calculation of some non-linear functions needs to be completed in the third stage, the multiplication unit and the addition unit are needed in the third subunit 54c. Each AU included in the third subunit 54c is not necessarily used each time the third stage is performed. For example, for different network layers in the neural network model, operations involved in the third stage may be different. The control unit 52 controls, based on the computer instruction read from the instruction memory 51, a corresponding AU in the third subunit 54c to perform a corresponding calculation. Some AUs that do not need to be used may be skipped in a bypass manner.

In some embodiments, as shown in FIG. 5, the control unit 52 includes an instruction decoder, a scheduler, and a manager. The instruction decoder is configured to decode the read computer instruction to obtain a first type of instruction and a second type of instruction, provide the first type of instruction to the scheduler, and provide the second type of instruction to the manager. The scheduler is configured to control the at least one neural network processing unit based on the first type of instruction. The at least one neural network unit is further configured to perform an operation in response to control of the scheduler. The manager is configured to control each register included in the quantum error correction hardware decoder based on the second type of instruction. Each register included in the quantum error correction hardware decoder is configured to perform a read/write operation in response to control of the manager.

An instruction fetched from the instruction memory 51 is decoded in the control unit 52, and then allocated to the scheduler or the manager based on an instruction type. The instruction decoding described herein is similar to what the instruction decoding in a classic computer (that is, at a value decoding stage in a classic computer) does. In other words, data such as an operation code, an address, and an operation number included in the instruction is respectively extracted for subsequent processing. Some basic network information (for example, including a quantity of parameters of the neural network model, addresses to which the parameters are stored, and addresses to which the results are stored) is also prestored in an on-chip memory of the decoder, and is accessed by the control unit 52 during running.

The scheduler receives related calculation execution (that is, the first type of instruction described above), and determines a particular operation to be executed in the neural network processing unit 54 by using a finite state machine (FSM). The manager is configured for scheduling communication between the register of the neural network processing unit 54 in each stage and an input/output data collector.

Different instructions are managed through the scheduler or the manager, which helps implement parallel execution of operations and read/write operations by the neural network processing unit 54, thereby improving efficiency of performing quantum error correction.

Compared with a classic processor, error decoding is a static process, and a quantity of execution periods of the entire neural network processing unit 54 and calculation division of each network layer can both be predetermined. Therefore, a very long instruction word (VLIW) method may be selected to reduce an instruction execution delay. Control instructions of the programmable decoder may be classified into two groups: a computation type instruction and a memory transfer type instruction, to be specific, the first type of instruction and the second type of instruction described above. The two groups of instructions are configured for respectively command the scheduler and the manager. Therefore, design of the control instruction basically represents a method for operating a configurable FSM in the control unit. A reason why different groups of scheduling instructions are based is that a delay of reading the memory may overlap with a time spent by the neural network processing unit 54 in executing the memory, thereby reducing an overall delay.

In addition, it is considered that calculation of a matrix vector in a single network layer may be excessively large to be completed in a single sub-process. Therefore, input data of a larger network layer is divided into a plurality of blocks, and calculation is performed based on a scheduling sequence according to an instruction. Therefore, in the third stage, one accumulator may be implemented to complete accumulation of execution results of different blocks. According to the instruction, network layer calculation that does not need to be partitioned may also bypass the accumulator. Correspondingly, sometimes, a plurality of relatively small network layers may also be processed in parallel in one neural network processing unit 54, and the foregoing prefetching mechanism in the second stage may help implement the parallelism.

An embodiment of the present disclosure provides a hardware implementation architecture of a quantum error correction decoding algorithm based on a neural network. The hardware architecture is a programmable architecture. A computer instruction configured for implementing the decoding algorithm may be pre-stored in an instruction memory. In a real-time decoding process, the control unit reads the computer instruction, and controls, based on the computer instruction, the neural network processing unit to decode the error syndrome information of the quantum circuit based on the neural network model, to finally obtain the error information. The foregoing hardware decoding architecture can efficiently run the quantum error correction decoding algorithm based on the neural network model, thereby fully reducing a decoding delay while ensuring decoding performance. In addition, in the foregoing hardware decoding architecture, a quantity of neural network processing units and a quantity of AUs included in the neural network processing units may be designed and extended based on an actual requirement. Therefore, the hardware decoding architecture provided in the present disclosure has good scalability and flexibility.

In addition, the decoding process of the neural network model is divided into the plurality of sub-processes performed in sequence, and the neural network processing unit is reused in different sub-processes, which improves resource utilization of the decoder, thereby reducing resource consumption during expansion to large-scale error-correction decoding, and meeting flexibility requirements in the face of different experimental environments.

In the foregoing embodiment, the decoding process of the neural network model is divided into a plurality of sub-processes performed in sequence, and the AU unit in the neural network processing unit 54 may be reused in different sub-processes.

In some embodiments, the neural network model is a multi-task classification neural network model. The neural network model is obtained by integrating a plurality of classification neural networks. Any classification neural network in the plurality of classification neural networks is configured to determine a decoding result corresponding to the error syndrome information. Exemplarily, the plurality of classification neural networks may share some network parameters.

In some embodiments, the division is performed based on functions. The neural network model includes a feature encoder and an error decoder. Working processes of the feature encoder and the error decoder belong to different sub-processes. The feature encoder is configured to extract the error syndrome information and generate feature information of the error syndrome information. The feature information is configured for representing a distribution feature in a feature space in the error syndrome information. The error decoder is configured to decode the feature information, to obtain the decoding result of the error syndrome information.

Exemplarily, the working process of the feature encoder is divided into at least one sub-process, and the working process of the error decoder may be divided into at least one sub-process.

Exemplarily, the error decoder of the neural network model includes a plurality of type decoders. A type decoder of the plurality of type decoders is configured to determine, based on the feature information, whether an error type (for example, a class-X error syndrome, or a class-Z error syndrome) occurs. The feature encoder and any type of decoder are combined to form a complete classification neural network. In other words, in this embodiment, the plurality of classification neural networks share a network parameter of the feature encoder. The manner helps reduce a parameter scale of the neural network model, and helps reduce a calculation amount in a process of determining an error type and a qubit in which an error occurs.

Exemplarily, the feature encoder is also referred to as a frontend or a feature extraction network. For example, the feature encoder may include a plurality of cascaded feature extraction subnetworks and a feature fusion subnetwork. A function of each feature extraction subnetwork is to extract local feature information in a divide and conquer manner. The feature fusion subnetwork finally summarizes and then compresses all local feature information to finally obtain feature information.

In some embodiments, a feature subnetwork is constructed based on a 3D CNN. The feature fusion subnetwork may be constructed based on a fully connected network. For example, the feature fusion subnetwork includes one or two fully connected layers. For feature information of the error syndrome information, the feature information needs to at least provide at least distribution calculation of a Pauli operator O(2^{L}^{²}⁺¹) for the type decoder, L representing a surface code scale.

In some embodiments, during generating the feature information, block feature extraction may be performed on the error syndrome information. In other words, when the feature information is extracted through the feature extraction subnetwork, the error syndrome information is partitioned into a plurality of small blocks, and feature extraction is performed on each small block. In other words, the block feature extraction means that after the input data is divided into at least two blocks, at least two feature extraction units are configured to perform feature extraction processing in parallel on the at least two blocks. The at least two blocks are in one-to-one correspondence with the at least two feature extraction units. Each feature extraction unit is configured to perform feature extraction on a block, and a quantity of blocks is the same as a quantity of feature extraction units. In addition, the at least two blocks perform the feature extraction in parallel, that is, simultaneously, thereby reducing time required for the feature extraction. If feature extraction is performed on at least two blocks in parallel, different processors need to respectively control the two blocks. The feature processing unit refers to a structure in a neural network model used by different processors to control. For a specific process of the plurality of processors working in parallel, reference is made to the following embodiments.

Exemplarily, the type decoder is also referred to as a backend or a feature decoding network. For example, the type decoder includes a feedforward neural network (FFN) layer. The type decoder is configured to generate a decoding result corresponding to the error syndrome information.

After the decoding results respectively generated by the plurality of type decoders are obtained, the error information is calculated based on the decoding results (that is, output results of the neural network model).

In some embodiments, a training process of the neural network model includes at least the following operations.

1. Obtain sample error syndrome information and sample error result information corresponding to the sample error syndrome information.

In some embodiments, the sample error syndrome information is randomly generated syndrome information (which may be an X or Z syndrome alone, or may include both types of syndromes), and the sample error result information corresponding to the sample error syndrome information is an error result corresponding to the syndrome information. The error result is obtained through one-hot encoding. The same syndrome information can correspond to different error results. Maintaining diversity of the output result at an output terminal helps the model to eventually learn an output probability distribution based on specific syndrome information during training.

2. Obtain predicted decoding results respectively determined by a plurality of error decoders based on the sample error syndrome information through a to-be-trained neural network model.

3. Determine loss function values respectively corresponding to a plurality of feature decoding networks based on the predicted decoding results respectively determined by the plurality of error decoders and the sample error syndrome information. In some embodiments, the loss function values may be calculated based on cross entropy.

4. Determine a total loss function value based on the loss function values respectively corresponding to the plurality of error decoders.

5. Adjust a parameter of the to-be-trained neural network model based on the total loss function value, to obtain a trained neural network model. In some embodiments, a parameter of the trained neural network model is stored in the quantum error correction hardware decoder. In some embodiments, a process of performing training on the to-be-trained neural network model is completed through another computer device.

In some embodiments, the AUs in the neural network processing unit 54 may also be allocated for use in the following manner. The neural network processing unit includes a plurality of AUs. The plurality of AUs are allocated to perform calculation on different network layers in the neural network model, and a quantity of AUs correspondingly allocated to each network layer in the neural network model is determined based on a total quantity of AUs included in the neural network processing unit and an operation quantity included in each network layer. In such an allocation manner, exclusive AUs are allocated to the different network layers, and adjacent network layers are connected through hard wiring. In other words, an input and an output of each adjacent network layer are directly connected through a specific data transmission line. This is also a good solution for a scenario where a surface code scale is relatively small (for example, L=5 or 7) and a network architecture of the neural network model is fixed. The foregoing scenario is referred to as a “specific network architecture”.

For a “specific network architecture”, the present disclosure provides a resource allocation model to optimize decoding performance. It is assumed that a total quantity of AUs included in the neural network processing unit is C, a quantity of network layers included in the neural network model is Nₗ, and j multiplication operations are performed on an Mⱼ^{th} layer of the neural network model. A quantity of AUs correspondingly allocated to the j^{th} layer of the neural network model is defined as Cⱼ. The problem is simplified as constrained optimization of partitioning on Cⱼ, which is described through the following equation.

$${min}_{{C}_{j}} {\sum }_{j}^{{N}_{l}} {α}_{j} \frac{{M}_{j}}{{C}_{j}} , where {\sum }_{j} {α}_{j} {C}_{j} = C$$

αⱼ is a quantity of independent operation parts on a j^{th} layer herein, which is determined based on the structure of the neural network model. For example, a value of αⱼ may be 1 or greater than 1. The foregoing problem may be solved through a Lagrange multiplier, to obtain some real-valued solutions Cⱼ, which are rounded to integers if constraints of the equation are satisfied. This simple heuristic method has proved to be effective, and shows excellent performance in the experiment.

In some embodiments, the quantum error correction hardware decoder may use a single-core architecture or a multi-core architecture. The single-core architecture and the multi-core architecture herein refer to a quantity of included processors (or referred to as processing cores).

In response to a single-core architecture, the quantum error correction hardware decoder includes a single processing core, and an entire decoding algorithm is completed through the single processing core. When the surface code scale Lis small, the single-core architecture can bear the computational complexity. However, when the surface code scale L is relatively large, the single-core architecture is limited. Therefore, the present disclosure provides a solution for the multi-core architecture.

In some embodiments, the quantum error correction hardware decoder includes a plurality of processing cores. Each of the processing cores is configured to process part of operations of the neural network model. Two processing cores with data dependency is connected through one or more data lines. In this embodiment of the present disclosure, the quantity of the processing cores included in the quantum error correction hardware decoder is not limited in the multi-core architecture, and may be specifically designed with reference to a size of the surface code scale L or computation complexity. On the premise that calculation power of each processing core is fully used, an entire decoding algorithm is completed.

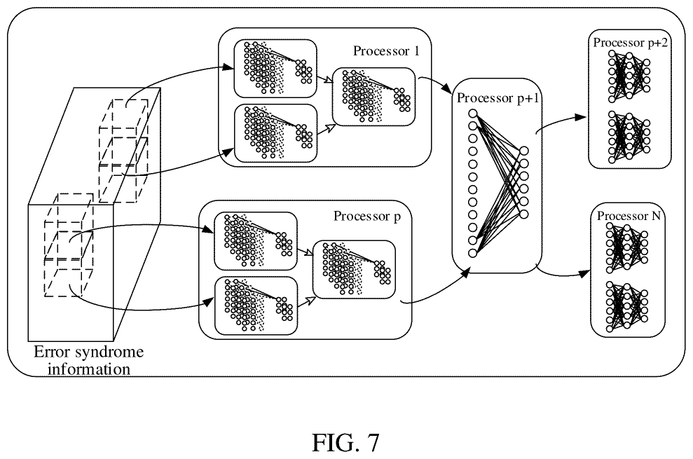

In response to the multi-core architecture, any two processing cores without data dependency have parallelism. In this way, a calculation capability of each processing core can be exerted to the greatest extent, and a decoding time can be shortened. In addition, any two processing cores with data dependency may be performed in sequence. For example, FIG. 7 shows a schematic diagram of a multi-core architecture. A connection does not exist between a processor 1 and a processor p. The p processors can perform in parallel, such as using a divide and conquer strategy to perform parallel processing on different blocks in error syndrome information. Operation results obtained by the processor 1 to the processor p are transmitted to a processor p+1. The processor p+1 performs further operation processing on the operation results provided by the processor 1 to the processor p. Then, the operation result of the processor p+1 is inputted to a processor p+2 to a processor N. The data dependency between the processor p+2 and the processor N does not exist. The plurality of processors can perform in parallel. Finally, an output result of the entire neural network model may be collected through a processor, and the error information is further determined based on the output result.

The plurality of processing cores herein form a tree-like structure. each processing core is responsible for a part of calculation in the 3D CNN or the fully connected network. For the step 3D CNN used herein, inputs of different processing cores are substantially independent, except input-output data transmission, almost no complex communication between processing cores is needed, and the same is true of the fully connected network configured for classification. Therefore, when each processing core is fully used, the architecture expands a parallel computing scale by adding more cores, to keep a decoding delay.

In such a multi-core architecture, only input and output data transmission between layers of networks needs to be completed, and the data exists in a form of vectors. A data volume of these vectors is not large. Therefore, it is a delay of single data transmission more concerned than a data transmission bandwidth. In the architecture, data transmission between different processing cores is constructed through a method based on an LVDS standard. First, no complex serial-to-parallel conversion protocol is added to an input/output terminal. A high-speed communication interface generally transmits serial data. Therefore, logical parallel data needs to be converted into serial data on an output terminal for transmitting, and received serial data needs to be converted into the parallel data on an input terminal. A serial-to-parallel conversion protocol commonly used in the industry, such as a common SerDes IP, needs to be used herein. However, operations of these protocols are relatively complex and have large delay overheads, and are not applicable to the scenario. For a real-time error correction decoding scenario involved in the present disclosure, alignment between data lines is pre-trained through a training code. In addition, a data rate is kept to a medium degree, for example, 1G to 1.5G, so that it is avoided that the data rate is excessively high and difficult to synchronize. Then, a quantity of channels between each group of data paths is increased based on the data rate. The data path herein is the communications interface mentioned above. Referring to FIG. 7, the data path is a black arrow between the processors. The quantity of channels is a quantity of parallel data lines in one data path. The used method is to use a plurality of data lines and transmit a plurality of groups of serial data in a parallel manner. By controlling the data rate, data on each data line herein does not need to perform the foregoing complex communication protocol, and data on each data line only needs to be pre-trained through the training code before formal communication, so as to ensure data alignment. In this manner, delay overheads of the communication protocol are avoided, and an entire bandwidth is ensured through a plurality of lines in parallel.

The measurement shows that such a data transmission method can obtain an extremely low transmission delay, causing expansion of the multi-core architecture to be possible. However, when a data volume that needs to be transmitted between cores is relatively large as a result of the surface code scale L being further increased, it can be deduced that Hamming weights of these vectors are relatively low by using the feature that the syndrome bits are sparse. In this case, a compression method may be selected to reduce the data volume between groups of transmission, thereby further reducing the delay. The method specifically includes the following operations. First, statistics on the Hamming weight in the data is collected, and the data is transmitted to a compressing module when it is determined that the Hamming weight of the data is less than a particular threshold. The compression module may include a plurality of data compression manners. For example, dynamic zero-set compression is dividing data into k blocks, then using a k-bit flag bit to indicate whether all corresponding blocks are all zero. If the corresponding blocks are all zero, a corresponding position is 1, and if the corresponding blocks are not zero, the corresponding position is 0, and the data of the block is added to a compressed result, k being an integer greater than 1. Different compression manners have different effects on different transmission data. Therefore, compression ratios of different compression manners are compared at the end of the compression module, and a result with a best compression ratio is selected to be finally used for data communication.

The experimental data related to the technical solutions of the present disclosure is described below.

First, L=5 and L=7 decoders are implemented on an FPGA platform through the specific network architecture described above, and delay results thereof are tested. A configuration and a delay result of the neural network model that is used are shown in Table 1.

TABLE 1
Delay results of different decoder configurations

| | Clock | Decoding |
|---|---|---|
| Decoder configuration | frequency | delay |
| Specific network architecture, L = 5, T = 10, N ≈ | 330 MHz | 197 ns |
| 90K | | |
| Specific network architecture, L = 5, T = 10, N ≈ | 300 MHz | 267 ns |
| 330K | | |
| Specific network architecture, L = 7, T = 14, N ≈ | 245 MHz | 1.1 us |
| 960K | | |

L represents a surface code scale, T represents a quantity of rounds of syndrome measurement, and N represents a quantity of parameters of the neural network model.

It can be seen that delay results of the three implemented decoders are all less than an expected delay value (1.5 us), which satisfy a real-time error correction requirement of a recent superconductive quantum computer. The L=7 decoder is also a currently known real-time decoder that has a largest scale and a lowest delay implemented by hardware.

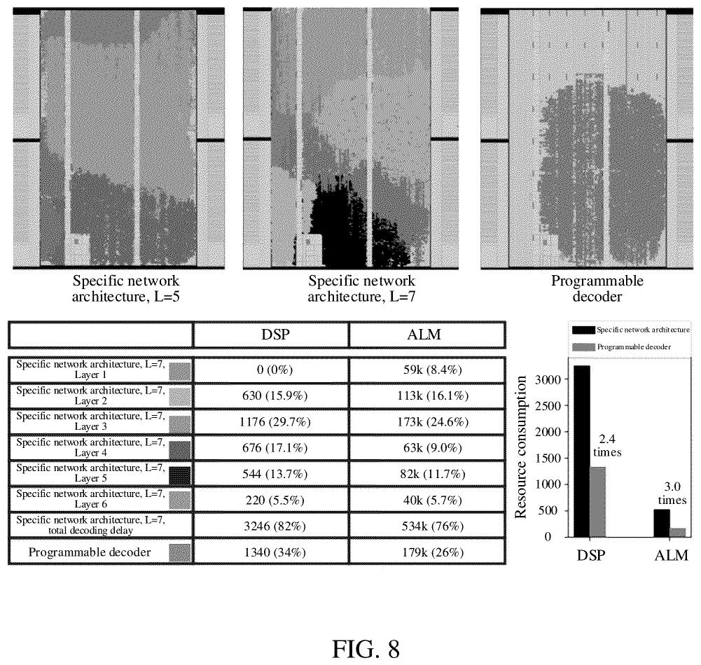

The programmable decoder described in the foregoing embodiment is also implemented on the same hardware platform. FIG. 8 is a schematic diagram of resource consumption of a programmable decoder and a specific network architecture. The three figures in the upper part are a display of a comprehensive status of the FPGA, and the table in the lower part provides consumption statuses of various resources. It can be seen that, on two types of main hardware resources, a digital signal processor (DSP) and an adaptive logic module (ALM), the programmable microarchitecture in this embodiment of the present disclosure reduces resource consumption by 2.4 times and 3.0 times compared with a specific network architecture. In addition, for a particular network architecture, different hardware implementations need to be respectively performed for different neural network configurations, and the programmable decoder may run different network configurations on the same hardware implementation, thereby achieving flexibility requirements, and causing the programmable decoder an optimal selection for a large-scale neural network decoder.

Various embodiments in the present disclosure include a quantum error correction decoder for decoding error syndrome information of a quantum circuit, the quantum error correction decoder comprising: a memory storing instructions, a neural network processing unit, and a processor in communication with the memory and the neural network processing unit; and wherein, when the processor executes the instructions, the processor is configured to cause the quantum error correction decoder to: obtain error syndrome information for an error syndrome measured due to an error occurring in a quantum circuit, decode, by the neural network processing unit, the error syndrome information of the quantum circuit based on a neural network model to obtain an output result of the neural network model, and determine error information based on the output result of the neural network model, the error information indicating a qubit in which an error occurs in the quantum circuit and a corresponding error type.

In some implementations, optionally or additionally to any one or any combinations of one or more implementations or embodiments in the present disclosure, the neural network model is divided into a plurality of sub-processes performed in sequence, and the neural network processing unit is reused in different sub-processes.

In some implementations, optionally or additionally to any one or any combinations of one or more implementations or embodiments in the present disclosure, each sub-process in the neural network model comprises a first stage, a second stage, and a third stage, the first stage is configured for performing a multiply-accumulate operation on input data of the sub-process, to obtain at least one first calculation result, the second stage is configured for performing an addition operation on the at least one first calculation result, to obtain at least one second calculation result, and the third stage is configured for obtaining output data of the sub-process based on the at least one second calculation result.

In some implementations, optionally or additionally to any one or any combinations of one or more implementations or embodiments in the present disclosure, the neural network processing unit comprises a first subunit, a second subunit, and a third subunit, the first subunit comprises at least one arithmetical unit (AU) configured to perform the first stage, the second subunit comprises at least one AU configured to perform the second stage, and the third subunit comprises at least one AU configured to perform the third stage.

In some implementations, optionally or additionally to any one or any combinations of one or more implementations or embodiments in the present disclosure, the first subunit further comprises a data operation unit and a weight operation unit, the data operation unit is configured to read the input data used in the first stage from a first register, and the weight operation unit is configured to read a weight parameter of the neural network model used in the first stage from a second register.

In some implementations, optionally or additionally to any one or any combinations of one or more implementations or embodiments in the present disclosure, the second subunit further comprises at least one multiplexer, and the multiplexer is configured to prefetch calculation results of different depths in an AU tree corresponding to the second stage.

In some implementations, optionally or additionally to any one or any combinations of one or more implementations or embodiments in the present disclosure, input data of a first sub-process in the plurality of sub-processes comprises the error syndrome information, and output data of a last sub-process in the plurality of sub-processes comprises the output result.

In some implementations, optionally or additionally to any one or any combinations of one or more implementations or embodiments in the present disclosure, the processor comprises an instruction decoder, a scheduler, and a manager, the instruction decoder is configured to decode an instruction to obtain a first type of instruction and a second type of instruction, provide the first type of instruction to the scheduler, and provide the second type of instruction to the manager, the scheduler is configured to control the neural network processing unit based on the first type of instruction, the neural network processing unit is further configured to perform an operation in response to the scheduler, the manager is configured to control one or more registers comprised in the quantum error correction decoder based on the second type of instruction, and each register comprised in the quantum error correction decoder is configured to perform a read or write operation in response to the manager.

In some implementations, optionally or additionally to any one or any combinations of one or more implementations or embodiments in the present disclosure, the quantum error correction decoder further includes a first register and a second register, the first register is configured to store input data used in a decoding process of the neural network model, and configured to store output data generated in the decoding process of the neural network model, and the second register is configured to store a weight parameter and a bias parameter of the neural network model.

In some implementations, optionally or additionally to any one or any combinations of one or more implementations or embodiments in the present disclosure, the neural network processing unit comprises a plurality of AUs, the plurality of AUs are allocated to perform calculation on different network layers in the neural network model, and a quantity of AUs allocated to each network layer in the neural network model are determined based on a total quantity of AUs comprised in the neural network processing unit and an operation quantity comprised in each network layer.

In some implementations, optionally or additionally to any one or any combinations of one or more implementations or embodiments in the present disclosure, the quantum error correction decoder further comprises: a plurality of processing cores, each of the processing cores is configured to process part of operations of the neural network model, and two processing cores with data dependency are connected through one or more data lines.

Various embodiments in the present disclosure include a quantum error correction hardware decoder, comprising an instruction memory, a control unit, at least one neural network processing unit, and an error merging and searching unit, the instruction memory being configured to store a computer instruction, the control unit being configured to read the computer instruction from the instruction memory and control the at least one neural network processing unit based on the computer instruction, the at least one neural network processing unit being configured to decode error syndrome information of a quantum circuit based on a neural network model in response to control of the control unit, to obtain an output result of the neural network model, the error syndrome information referring to an error syndrome measured due to an error occurring in the quantum circuit, and the error merging and searching unit being configured to determine error information based on the output result, the error information being configured for indicating a qubit in which an error occurs in the quantum circuit and a corresponding error type.

In some implementations, optionally or additionally to any one or any combinations of one or more implementations or embodiments in the present disclosure, a decoding process of the neural network model is divided into n sub-processes performed in sequence, the neural network processing unit being reused in different sub-processes, and n being an integer greater than 1.

In some implementations, optionally or additionally to any one or any combinations of one or more implementations or embodiments in the present disclosure, each sub-process comprises a first stage, a second stage, and a third stage, the first stage being configured for performing a multiply-accumulate operation on input data of the sub-process, to obtain at least one first calculation result, the second stage being configured for performing an addition operation on the at least one first calculation result, to obtain at least one second calculation result, and the third stage being configured for obtaining output data of the sub-process based on the at least one second calculation result.

In some implementations, optionally or additionally to any one or any combinations of one or more implementations or embodiments in the present disclosure, the neural network processing unit comprises a first subunit, a second subunit, and a third subunit, the first subunit comprising at least one arithmetical unit (AU) configured to perform the first stage, the second subunit comprising at least one AU configured to perform the second stage, and the third subunit comprising at least one AU configured to perform the third stage.

In some implementations, optionally or additionally to any one or any combinations of one or more implementations or embodiments in the present disclosure, the first subunit further comprises a data operation unit and a weight operation unit, the data operation unit being configured to read the input data used in the first stage from a first register, and the weight operation unit being configured to read a weight parameter of the neural network model used in the first stage from a second register.

In some implementations, optionally or additionally to any one or any combinations of one or more implementations or embodiments in the present disclosure, the second subunit further comprises at least one multiplexer, the multiplexer being configured to prefetch calculation results of different depths in an AU tree corresponding to the second stage.

In some implementations, optionally or additionally to any one or any combinations of one or more implementations or embodiments in the present disclosure, input data of a first sub-process in the n sub-processes comprises the error syndrome information, and output data of a last sub-process in the n sub-processes comprises the output result.

In some implementations, optionally or additionally to any one or any combinations of one or more implementations or embodiments in the present disclosure, the control unit comprises an instruction decoder, a scheduler, and a manager, the instruction decoder being configured to decode the read computer instruction to obtain a first type of instruction and a second type of instruction, provide the first type of instruction to the scheduler, and provide the second type of instruction to the manager, the scheduler being configured to control the at least one neural network processing unit based on the first type of instruction, the at least one neural network unit being further configured to perform an operation in response to control of the scheduler, the manager being configured to control each register comprised in the quantum error correction hardware decoder based on the second type of instruction, and each register comprised in the quantum error correction hardware decoder being configured to perform a read/write operation in response to control of the manager.

In some implementations, optionally or additionally to any one or any combinations of one or more implementations or embodiments in the present disclosure, the quantum error correction hardware decoder further comprises the first register and the second register, the first register being configured to store input data used in a decoding process of the neural network model, and configured to store output data generated in the decoding process of the neural network model, and the second register being configured to store a weight parameter and a bias parameter of the neural network model.

In some implementations, optionally or additionally to any one or any combinations of one or more implementations or embodiments in the present disclosure, the neural network processing unit comprises a plurality of AUs, the plurality of AUs being allocated to perform calculation on different network layers in the neural network model, and a quantity of AUs allocated to each network layer in the neural network model being determined based on a total quantity of AUs comprised in the neural network processing unit and an operation quantity comprised in each network layer.

In some implementations, optionally or additionally to any one or any combinations of one or more implementations or embodiments in the present disclosure, the quantum error correction hardware decoder further comprises a plurality of processing cores, each of the processing cores being configured to process part of operations of the neural network model, and two processing cores with data dependency being connected through one or more data lines.

An exemplary embodiment of the present disclosure further provides a chip. The chip has the quantum error correction hardware decoder provided in the foregoing embodiments deployed. In some embodiments, the chip is an FPGA chip or an ASIC chip.

“Plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in the embodiments of the present disclosure.

In various embodiments in the present disclosure, a unit may refer to a software unit, a hardware unit, or a combination thereof. A software unit may include a computer program or part of the computer program that has a predefined function and works together with other related parts to achieve a predefined goal, such as those functions described in this disclosure. A hardware unit may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

What are disclosed above are merely examples of embodiments of this application, and certainly are not intended to limit the protection scope of this application. Therefore, equivalent variations made in accordance with the claims of this application shall fall within the scope of this application.

What is claimed is:

1. A quantum error correction decoder for decoding error syndrome information of a quantum circuit, the quantum error correction decoder comprising:
a memory storing instructions, a neural network processing unit, and a processor in communication with the memory and the neural network processing unit; and
wherein, when the processor executes the instructions, the processor is configured to cause the quantum error correction decoder to:
obtain error syndrome information for an error syndrome measured due to an error occurring in a quantum circuit,
decode, by the neural network processing unit, the error syndrome information of the quantum circuit based on a neural network model to obtain an output result of the neural network model, and
determine error information based on the output result of the neural network model, the error information indicating a qubit in which an error occurs in the quantum circuit and a corresponding error type.

2. The quantum error correction decoder according to claim 1, wherein:
the neural network model is divided into a plurality of sub-processes performed in sequence, and the neural network processing unit is reused in different sub-processes.

3. The quantum error correction decoder according to claim 2, wherein:
each sub-process in the neural network model comprises a first stage, a second stage, and a third stage,
the first stage is configured for performing a multiply-accumulate operation on input data of the sub-process, to obtain at least one first calculation result,
the second stage is configured for performing an addition operation on the at least one first calculation result, to obtain at least one second calculation result, and
the third stage is configured for obtaining output data of the sub-process based on the at least one second calculation result.

4. The quantum error correction decoder according to claim 3, wherein:
the neural network processing unit comprises a first subunit, a second subunit, and a third subunit,
the first subunit comprises at least one arithmetical unit (AU) configured to perform the first stage,
the second subunit comprises at least one AU configured to perform the second stage, and
the third subunit comprises at least one AU configured to perform the third stage.

5. The quantum error correction decoder according to claim 4, wherein:
the first subunit further comprises a data operation unit and a weight operation unit,
the data operation unit is configured to read the input data used in the first stage from a first register, and
the weight operation unit is configured to read a weight parameter of the neural network model used in the first stage from a second register.

6. The quantum error correction decoder according to claim 4, wherein:
the second subunit further comprises at least one multiplexer, and
the multiplexer is configured to prefetch calculation results of different depths in an AU tree corresponding to the second stage.

7. The quantum error correction decoder according to claim 2, wherein:
input data of a first sub-process in the plurality of sub-processes comprises the error syndrome information, and
output data of a last sub-process in the plurality of sub-processes comprises the output result.

8. The quantum error correction decoder according to claim 1, wherein:
the processor comprises an instruction decoder, a scheduler, and a manager,
the instruction decoder is configured to decode an instruction to obtain a first type of instruction and a second type of instruction, provide the first type of instruction to the scheduler, and provide the second type of instruction to the manager,
the scheduler is configured to control the neural network processing unit based on the first type of instruction,
the neural network processing unit is further configured to perform an operation in response to the scheduler,
the manager is configured to control one or more registers comprised in the quantum error correction decoder based on the second type of instruction, and
each register comprised in the quantum error correction decoder is configured to perform a read or write operation in response to the manager.

9. The quantum error correction decoder according to claim 1, further comprising:
a first register and a second register,
the first register is configured to store input data used in a decoding process of the neural network model, and configured to store output data generated in the decoding process of the neural network model, and
the second register is configured to store a weight parameter and a bias parameter of the neural network model.

10. The quantum error correction decoder according to claim 1, wherein:
the neural network processing unit comprises a plurality of AUs,
the plurality of AUs are allocated to perform calculation on different network layers in the neural network model, and
a quantity of AUs allocated to each network layer in the neural network model are determined based on a total quantity of AUs comprised in the neural network processing unit and an operation quantity comprised in each network layer.

11. The quantum error correction decoder according to claim 1, further comprising:
a plurality of processing cores,
each of the processing cores is configured to process part of operations of the neural network model, and
two processing cores with data dependency are connected through one or more data lines.

12. A chip for decoding error syndrome information of a quantum circuit, the chip comprising:
a quantum error correction decoder comprising a memory storing instructions, a neural network processing unit, and a processor in communication with the memory and the neural network processing unit; and
wherein, when the processor executes the instructions, the processor is configured to cause the quantum error correction decoder to:
obtain error syndrome information for an error syndrome measured due to an error occurring in a quantum circuit,
decode, by the neural network processing unit, the error syndrome information of the quantum circuit based on a neural network model to obtain an output result of the neural network model, and
determine error information based on the output result of the neural network model, the error information indicating a qubit in which an error occurs in the quantum circuit and a corresponding error type.

13. The chip according to claim 12, wherein:
the neural network model is divided into a plurality of sub-processes performed in sequence, and the neural network processing unit is reused in different sub-processes.

14. The chip according to claim 13, wherein:
each sub-process in the neural network model comprises a first stage, a second stage, and a third stage,
the first stage is configured for performing a multiply-accumulate operation on input data of the sub-process, to obtain at least one first calculation result,
the second stage is configured for performing an addition operation on the at least one first calculation result, to obtain at least one second calculation result, and
the third stage is configured for obtaining output data of the sub-process based on the at least one second calculation result.

15. The chip according to claim 14, wherein:
the neural network processing unit comprises a first subunit, a second subunit, and a third subunit,
the first subunit comprises at least one arithmetical unit (AU) configured to perform the first stage,
the second subunit comprises at least one AU configured to perform the second stage, and
the third subunit comprises at least one AU configured to perform the third stage.

16. The chip according to claim 15, wherein:
the first subunit further comprises a data operation unit and a weight operation unit,
the data operation unit is configured to read the input data used in the first stage from a first register, and
the weight operation unit is configured to read a weight parameter of the neural network model used in the first stage from a second register.

17. The chip according to claim 15, wherein:
the second subunit further comprises at least one multiplexer, and
the multiplexer is configured to prefetch calculation results of different depths in an AU tree corresponding to the second stage.

18. The chip according to claim 12, wherein:
the processor comprises an instruction decoder, a scheduler, and a manager,
the instruction decoder is configured to decode an instruction to obtain a first type of instruction and a second type of instruction, provide the first type of instruction to the scheduler, and provide the second type of instruction to the manager,
the scheduler is configured to control the neural network processing unit based on the first type of instruction,
the neural network processing unit is further configured to perform an operation in response to the scheduler,
the manager is configured to control one or more registers comprised in the quantum error correction decoder based on the second type of instruction, and
each register comprised in the quantum error correction decoder is configured to perform a read or write operation in response to the manager.

19. The chip according to claim 12, wherein the quantum error correction decoder further comprises:
a first register and a second register,
the first register is configured to store input data used in a decoding process of the neural network model, and configured to store output data generated in the decoding process of the neural network model, and
the second register is configured to store a weight parameter and a bias parameter of the neural network model.

20. The chip according to claim 12, wherein:
the chip is a field programmable gate array (FPGA) chip or an application specific integrated circuit (ASIC) chip.
